(19) United States
(12) Patent Application Publication
(10) Pub. No.: US 2016/0248552 A1
(43) Pub. Date: Aug. 25, 2016

(54) METHOD AND APPARATUS FOR COVERAGE ENHANCEMENT IN WIRELESS COMMUNICATION SYSTEM

(71) Applicant: NEC (CHINA) CO., LTD., Beijing (CN)

(72) Inventors: Gang WANG, Beijing (CN); Zhennian SUN, Beijing (CN); Ming LEI, Beijing (CN)

(73) Assignee: NEC (CHINA) CO., LTD., Beijing (CN)

(21) Appl. No.: 15/022,817

(22) PCT Filed: Sep. 18, 2013
(86) PCT No.: PCT/CN2013/083758

§ 371 Date: Mar. 17, 2016

(51) Int. Cl. H04L 1/18; H04W 24/02

(52) U.S. Cl. CPC H04L 1/1861; H04W 24/02

(57) ABSTRACT

Embodiments of the disclosure provide methods and apparatuses for coverage enhancement in a wireless communication system. In a method according to embodiments of the present invention, a PHICH resource set including a plurality of PHICH resources is determined, and an ACK/NACK message is spread by using the plurality of PHICH resources, such that spreading results of the ACK/NACK message are sent to a UE in the plurality of PHICH resources.

### FIELD OF THE INVENTION

Embodiments of the present invention generally relate to communication techniques. More particularly, embodiments of the present invention relate to a method and apparatus for coverage enhancement in a wireless communication system.

### BACKGROUND OF THE INVENTION

3GPP LTE and LTE-Advanced, also known as the evolution standard of the great success of GSM/HSPA technology, create a new series of specifications and standards for the next generation cellular communication technology. LTE and LTE-Advanced have two different duplex modes for separating the transmission directions from the user to the base station and back: Frequency Division Duplex (FDD) and Time Division Duplex (TDD).

In order to combat the occurrence of decoding failure at initial transmission, LTE adopts Hybrid Automatic Repeat Request (HARQ) for retransmission of the decoding-failed data on the physical layer. HARQ is a technique in which, when decoding has failed, the receiver sends the transmitter a Negative Acknowledgement (NACK), enabling the transmitter to retransmit the decoding-failed data. If the data is decoded successfully, the receiver sends the transmitter an Acknowledgement (ACK), enabling the transmitter to send new data.

Machine-Type Communications (MTC), also called as Machine-to-Machine (M2M) communication, is an emerging communication pattern. Many MTC user equipments (UEs) are targeting low-end (such as, low average revenue per user, and low data rate) applications that can be handled adequately by GSM/GPRS.

As LTE deployments evolve, it is desirable to reduce the cost of overall network maintenance by minimising the number of Radio Access Technologies (RATs). However, there are deployed more and more MTC UEs in the field, which increases reliance on GSM/GPRS networks, and thus cost for operating these networks is increased. Hence, it will be very beneficial if low-end MTC UEs may be migrated from GSM/GPRS to LTE Networks.

In LTE release 8 to 11, data transmission is designed for medium or high Signal to Noise Ratio (SNR), i.e. SNR>−5 dB. MTC UE's SNR could be as low as −25.3 dB. It is quite challenging to support MTC UE in current available LTE release. 3GPP has started a study item (SID: RP-121441) to study the possible method to support MTC UE in low SNR region. A technical report (TR 36.888) has been prepared. In RANP #60, WID (RP-130848) proposed to “Simplification of PHICH and PCFICH functionality or alternative mechanism to PHICH and PCFICH functionality so that coverage limited UE is not constrained by PHICH and PCFICH physical channels.”

However, according to the existing solutions, in the case of low SNR, the ratio of successful transmission of the ACK/NACK message on Physical Hybrid ARQ Indicator Channel (PHICH) is rather low.

In view of the foregoing problems, it would be desirable to enhance PHICH coverage, so as to improve the ratio of successful transmission of the ACK/NACK message.

### SUMMARY OF THE INVENTION

To address or mitigate at least one of the above potential problems, embodiments of the present invention would propose to enhance PHICH coverage. Specifically, embodiments of the present invention provide solutions for spreading an ACK/NACK message by using a plurality of PHICH resources, such that the ratio of successful transmission of the ACK/NACK message on PHICH is improved.

According to a first aspect of the present invention, embodiments of the invention provide a method for coverage enhancement in a wireless communication system. The method may comprise steps of: determining a PHICH resource set including a plurality of PHICH resources; and spreading an ACK/NACK message by using the plurality of PHICH resources, such that spreading results of the ACK/NACK message are sent to a UE in the plurality of PHICH resources.

According to a second aspect of the present invention, embodiments of the invention provide a method for coverage enhancement in a wireless communication system. The method may comprise steps of: determining a PHICH resource set including a plurality of PHICH resources; receiving spreading results of an ACK/NACK message which are sent from a base station (BS) in the plurality of PHICH resources; and obtaining the ACK/NACK message based on the spreading results of the ACK/NACK message.

According to a third aspect of the present invention, embodiments of the invention provide an apparatus for coverage enhancement in a wireless communication system. The apparatus may comprise: a determiner configured to determine a PHICH resource set including a plurality of PHICH resources; and a spreader configured to spread an ACK/NACK message by using the plurality of PHICH resources, such that spreading results of the ACK/NACK message are sent to a UE in the plurality of PHICH resources.

According to a fourth aspect of the present invention, embodiments of the invention provide an apparatus for coverage enhancement in a wireless communication system. The apparatus may comprise: a determiner configured to determine a PHICH resource set including a plurality of PHICH resources; a receiver configured to receive spreading results of an ACK/NACK message which are sent from a BS in the plurality of PHICH resources; and an obtainer configured to obtain the ACK/NACK message based on the spreading results of the ACK/NACK message.

The following benefits are expected with the invention. With the solution according to the present invention, the ratio of successful transmission of the ACK/NACK message on PHICH is effectively improved, especially in a situation that the SNR is quite low.

Other features and advantages of the embodiments of the present invention will also be apparent from the following description of specific embodiments when read in conjunction with the accompanying drawings, which illustrate, by way of example, the principles of embodiments of the invention.

### BRIEF DESCRIPTION OF THE DRAWINGS

Embodiments of the invention are presented in the sense of examples and their advantages are explained in greater detail below, with reference to the accompanying drawings, where

FIG. 1 illustrates a schematic diagram 100 of an Hybrid Automatic Repeat Request (HARQ) operation in a wireless communication system;

FIG. 2 illustrates a flow chart of a method 200 for coverage enhancement in a wireless communication system according to embodiments of the invention;

FIG. 3 illustrates a flow chart of a method 300 for coverage enhancement in a wireless communication system according to further embodiments of the invention;

FIG. 4 illustrates a block diagram 400 of modules in a BS according to further embodiments of the invention;

FIG. 5 illustrates a flow chart of a method 500 for coverage enhancement in a wireless communication system according to embodiments of the invention;

FIG. 6 illustrates a flow chart of a method 600 for coverage enhancement in a wireless communication system according to further embodiments of the invention;

FIG. 7 illustrates a block diagram 700 of modules in a UE according to further embodiments of the invention;

FIG. 8 illustrates a block diagram of an apparatus 800 for coverage enhancement in a wireless communication system according to embodiments of the invention; and

FIG. 9 illustrates a block diagram of an apparatus 900 for coverage enhancement in a wireless communication system according to further embodiments of the invention.

### DETAILED DESCRIPTION OF EMBODIMENTS

Embodiments of the invention will be described thoroughly hereinafter with reference to the accompanying drawings. It will be apparent to those skilled in the art that the invention may, however, be embodied in many different forms and should not be construed as limited to the embodiments and specific details set forth herein. Like numbers refer to like elements throughout the specification.

The features, structures, or characteristics of the invention described throughout this specification may be combined in any suitable manner in one or more embodiments. For example, the usage of the phrases “certain embodiments,” “some embodiments,” or other similar language, throughout this specification refers to the fact that a particular feature, structure, or characteristic described in connection with the embodiment may be included in at least one embodiment of the present invention. Thus, appearances of the phrases “in certain embodiments,” “in some embodiments,” “in other embodiments,” or other similar language, throughout this specification do not necessarily all refer to the same group of embodiments, and the described features, structures, or characteristics may be combined in any suitable manner in one or more embodiments.

In the disclosure, a user equipment (UE) may refer to a terminal, a Mobile Terminal (MT), a Subscriber Station (SS), a Portable Subscriber Station (PSS), Mobile Station (MS), or an Access Terminal (AT), and some or all of the functions of the UE, the terminal, the MT, the SS, the PSS, the MS, or the AT may be included.

In the disclosure, a base station (BS) may refer to a node B (NodeB or NB) or an evolved NodeB (eNodeB or eNB). A base station may be a macrocell BS or a small cell BS. According to the present invention, a macrocell BS may be a base station which manages a macrocell, for example, a macro eNB, and a small cell BS may be a base station which manages a small cell, for example, a pico eNB, a femto eNB, and some other suitable low power nodes.

Reference is first made to FIG. 1, which illustrates a schematic diagram of an HARQ operation in a wireless communication system.

For better understanding, the following embodiments of the present disclosure are described under the LTE system. As can be appreciated by those skilled in the art, the present disclosure can be applicable to any other suitable communication environment, but not limited to the specific arrangement.

As Shown in FIG. 1, in uplink transmission, UE transmits data in Physical Uplink Shared Channel (PUSCH). In the case that decoding of the transmitted data is successful, eNodeB may send an Acknowledgement (ACK) message in PHICH to the UE, enabling the UE to send new data. When the decoding is failed, the eNodeB may send a Negative Acknowledgement (NACK) message in PHICH to the UE, enabling the UE to retransmit the decoding-failed data. In response to the NACK message, the UE may carry out the retransmission.

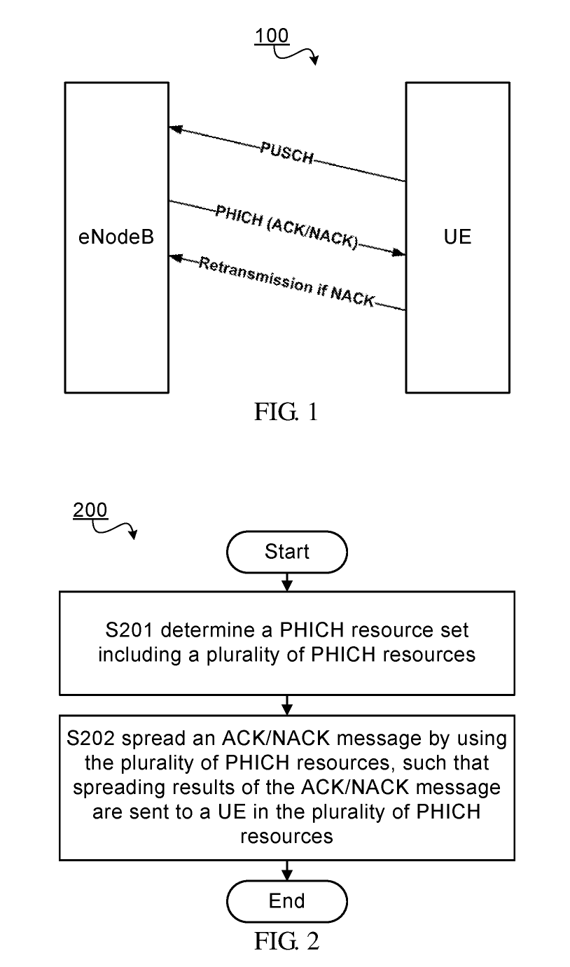

To improve the ratio of successful transmission of the ACK/NACK message in PHICH, e.g., in a low SNR environment, embodiments of the present invention propose solutions to enhance PHICH coverage. Reference is first made to FIG. 2, which illustrates a flow chart of a method for coverage enhancement in a wireless communication system according to embodiments of the invention. In accordance with embodiments of the present invention, the method 200 may be carried out by a BS or some other suitable device, or may be carried out by an apparatus comprised in the BS.

After the method 200 starts, at step S201, a PHICH resource set including a plurality of PHICH resources is determined.

In accordance with embodiments of the present invention, the PHICH resource set may comprise a plurality of PHICH resources. The PHICH resources may comprise PHICH sequences, powers, and/or other suitable resources.

In some embodiments, the plurality of PHICH resources comprise a plurality of powers, thus a PHICH resource set including the plurality of powers may be determined at step S201.

In some other embodiments, the plurality of PHICH resources comprise a plurality of PHICH sequences, thus a PHICH resource set including the plurality of PHICH sequences may be determined at step S201. According to embodiments of the present invention, a PHICH sequence may be identified by an index pair (n_{PHICH}^{group},n_{PHICH}^{seq}), where n_{PHICH}^{group} is the PHICH group number and n_{PHICH}^{seq} is the orthogonal sequence index within the group. By determining multiple index pairs indentifying the plurality of PHICH sequences, the PHICH resource set may be determined. Specifically, information about the PHICH resource set may be obtained first, and a plurality of index pairs indentifying the plurality of PHICH sequences in the PHICH resource set may be determined based on PHICH parameters and the information about the PHICH resource set. According to embodiments of the present invention, the information about the PHICH resource set may comprise size of the PHICH resource set, which indicates the number of the resources (e.g., sequences) in the PHICH resource set, and/or other suitable information. The PHICH parameters may comprise a spreading factor size used for PHICH modulation, a number of PHICH groups, a factor mapped from the cyclic shift for Demodulation reference signal (DMRS) field, an index for a transport block (TB) of Physical Uplink Shared Channel (PUSCH), an indicator of TDD uplink/downlink configuration, and/or other suitable parameters.

In accordance with embodiments of the present invention, the plurality of PHICH sequences may belong to one PHICH group. In other words, the plurality PHICH sequences may have the same group index. In this case, the plurality of index pairs indentifying the plurality of PHICH sequences may be determined by:

n_{PHICH,m}^{group}=(I_{PRB}_{_}_{RA}^{lowest}^{_}^{index}+n_{DMRS})mod N_{PHICH}^{group}+I_{PHICH}N_{PHICH}^{group}

n_{PHICH,m}^{seq}=(└I_{PRB}_{_}_{RA}^{lowest}^{_}^{index}/N_{PHICH}^{group}┘+n_{DMRS}+m)mod 2N_{SF}^{PHICH} (1)

where m=0, 1, 2, . . . , M−1, and M is the size of the PHICH resource set;
n_{PHICH,m}^{group} indicates the group index of the m^{th} sequence in the PHICH resource set;
n_{PHICH,m}^{seq} indicates the sequence index of the m^{th} sequence in the PHICH resource set;
N_{SF}^{PHICH} indicates a spreading factor size used for PHICH modulation;
N_{PHICH}^{group} indicates a number of PHICH groups;
I_{PHICH} indicates an indicator of TDD uplink/downlink (UL/DL) configuration,
   wherein

$${I}_{PHICH} = \{ \begin{matrix}1 & \begin{matrix}for TDD UL / DL configuration 0 with PUSCH \\ transmission in subframe n = 4 or 9\end{matrix} \\ 0 & otherwise\end{matrix} ;$$

I_{PRB}_{_}_{RA} indicates an index for a TB of PUSCH,
   wherein

$${I}_{PRB\_RA} = \{ \begin{matrix}{I}_{PRB\_RA}^{lowest\_index} & \begin{matrix}for the first TB of a PUSCH with associated \\ PDCCH or for the case of no associated PDCCH \\ when the number of negatively acknowledged \\ TBs is not equal to the number of TBs indicated \\ in the most recent PDCCH associated with the \\ corresponding PUSCH\end{matrix} \\ {I}_{PRB\_RA}^{lowest\_index} + 1 & \begin{matrix}for a second TB of a PUSCH with associated \\ PDCCH \end{matrix}\end{matrix}$$

where I_{PRB}_{_}_{RA}^{lowest}^{_}^{index} is the lowest Physical Resource Block (PRB) index in the first slot of the corresponding PUSCH transmission; and
n_{DMRS} indicates a factor mapped from the cyclic shift for DMRS field.
   Specifically, n_{DMRS} is mapped from the cyclic shift for DMRS field (e.g., according to TS.36.213 Table 9.1.2-2) in the most recent PDCCH with uplink DCI format for the transport block(s) associated with the corresponding PUSCH transmission. n_{DMRS} shall be set to zero, if there is no PDCCH with uplink DCI format for the same transport block, and
if the initial PUSCH for the same transport block is semi-persistently scheduled, or
if the initial PUSCH for the same transport block is scheduled by the random access response grant.

As an alternative, the plurality of PHICH sequences may belong to multiple PHICH groups. In other words, the plurality PHICH sequences may have different group indices. In this case, the plurality of index pairs indentifying the plurality of PHICH sequences (denoted as (n_{PHICH,m}^{group},n_{PHICH,m}^{seq}), m=0, 1, 2, . . . , M−1) may be determined by:

n_{PHICH,m}^{group}=(I_{PRB}_{_}_{RA}^{lowest}^{_}^{index}+n_{DMRS}+m)mod N_{PHICH}^{group}+I_{PHICH}N_{PHICH}^{group}

n_{PHICH,m}^{seq}=(└I_{PRB}_{_}_{RA}^{lowest}^{_}^{index}/N_{PHICH}^{group}┘+n_{DMRS}+m)mod 2N_{SF}^{PHICH} (1)

where the parameters in equation (2) have the same meaning as those in equation (1).

At step S202, an ACK/NACK message is spread by using the plurality of PHICH resources, such that spreading results of the ACK/NACK message are sent to a UE in the plurality of PHICH resources.

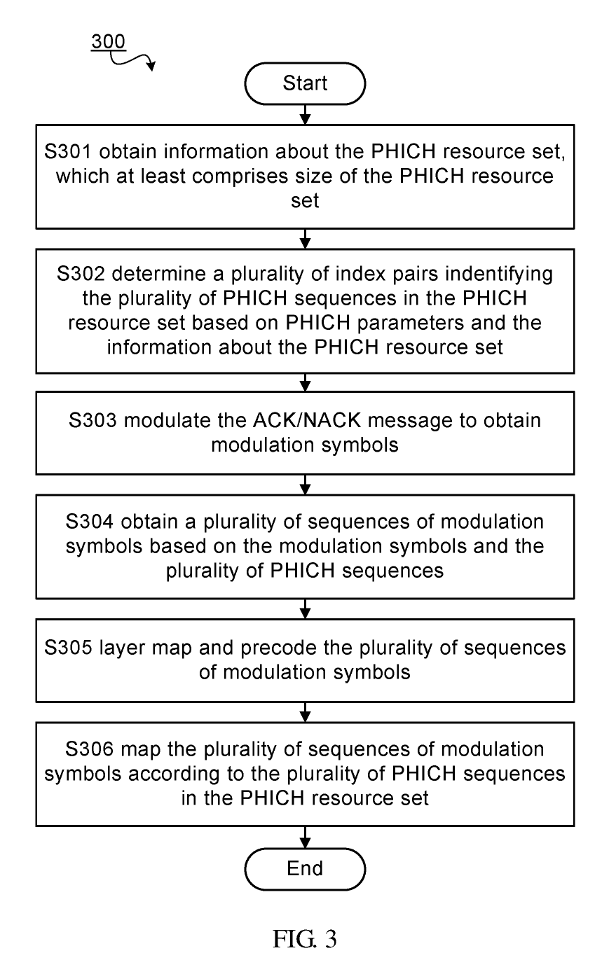

The ACK/NACK message may be spread in several ways. In some embodiments, the ACK/NACK message may be modulated to obtain modulation symbols; a plurality of sequences of modulation symbols may be obtained based on the modulation symbols and the plurality of PHICH sequences; the plurality of sequences of modulation symbols may be layer mapped and precoded; and the plurality of sequences of modulation symbols may be mapped according to the plurality of PHICH sequences in the PHICH resource set. Details will be described in connection with embodiments of FIG. 3.

In accordance with embodiments of the present invention, the method 200 may optionally comprise a step of judging whether the UE needs coverage enhancement. In response to that the UE needs the coverage enhancement, the PHICH resource set may be determined, as discussed in step S201. According to embodiments of the present invention, whether the UE needs coverage enhancement may be determined in several ways. For example, if the SNR is lower than a predefined threshold, it may be determined that the UE needs coverage enhancement. As can be appreciated by those skilled in the art, the above example is just for illustration, rather than limitation.

In accordance with embodiments of the present invention, the method 200 may optionally comprise a step of sending information about the PHICH resource set to the UE, wherein the information about the PHICH resource set at least comprises size of the PHICH resource set. It is to be noted that the information sending step is optional. In some embodiments, the information about the PHICH resource set may be initially set as a fixed value at both the UE and the BS. As such, during the HARQ operation, both the UE and the BS will employ the same information about the PHICH resource set, and there is no need to transmit such information in real time. If the information about the PHICH resource set is not known to the UE, the BS may inform the UE this information, so as that the UE may determine the index pairs of the plurality of PHICH sequences.

Reference is first made to FIG. 3, which illustrates a flow chart of a method for coverage enhancement in a wireless communication system according to further embodiments of the invention. The method 300 may be considered as an embodiment of the method 200 described above with reference to FIG. 2. In the following description of method 300, the information about the PHICH resource set is first obtained at a BS and then index pairs indentifying the plurality of PHICH sequences is determined based on the information. As such, the ACK/NACK message may be spread by using the plurality of PHICH sequences. However, it is noted that this is only for the purpose of illustrating the principles of the present invention, rather than limiting the scope thereof.

At step S301, obtain information about the PHICH resource set, which at least comprises size of the PHICH resource set.

In accordance with embodiments of the present invention, the information about the PHICH resource set may be obtained in several ways. For example, the information about the PHICH resource set may be preset at the BS and stored in a memory or a storage, thus the BS may extract the information from the memory or storage at step S301.

At step S302, a plurality of index pairs indentifying the plurality of PHICH sequences in the PHICH resource set are determined based on PHICH parameters and the information about the PHICH resource set.

The PHICH parameters may comprise a spreading factor size used for PHICH modulation, a number of PHICH groups, a factor mapped from the cyclic shift for DMRS field, an index for a TB of PUSCH, an indicator of TDD uplink/downlink configuration, and/or other suitable parameters. The PHICH parameters may be obtained at both the BS and the UE according to existing ways, which are not detailed here.

Step S302 in method 300 may be considered as an implementation of step S201 in method 200 as described above. The plurality of index pairs indentifying the plurality of PHICH sequences in the PHICH resource set may be determined according to equation (1) if the plurality of PHICH sequences belong to one PHICH group, or may be determined according to equation (2) when the plurality of PHICH sequences belong to multiple PHICH groups.

At step S303, the ACK/NACK message is modulated to obtain modulation symbols.

According to embodiments of the present invention, when the BS receives packets from the UE, it may generate an ACK/NACK message (e.g., one or more bits) to indicate the UE whether the packets has been successfully received. The ACK/NACK message, for example, one bit of 1 or 0, may be firstly repeated predefined times (e.g., 3 times) to increase the transmission robustness. For example, an ACK bit 1 may be repeated 3 times to a block of bits {1, 1, 1}. After the repetition, the ACK/NACK message may be modulated to be one or more modulation symbols. The modulation may be implemented in existing ways, for example, by using BPSK according to 6.9.1 of TS. 36.211, which are not detailed here.

At step S304, a plurality of sequences of modulation symbols are obtained based on the modulation symbols and the plurality of PHICH sequences.

The block of bits b(0), . . . , b(M_{bit}−1) of the ACK/NACK message transmitted on one PHICH in one subframe may be modulated at step S303, resulting in a block of complex-valued modulation symbols z(0), . . . , z(Mₛ−1), where Mₛ=M_{bit}, and M_{bit} is the number of the bits of the ACK/NACK message.

The block of modulation symbols z(0), . . . , z(Mₛ−1) may be symbol-wise multiplied with a set of orthogonal sequences and scrambled, resulting in a plurality of sequences of modulation symbols. The plurality of sequences of modulation symbols may be denoted as d(m,0), . . . , d(m,M_{symb}−1) and may be obtained according to:

d(m,i)=wₘ(i mod N_{SF}^{PHICH})·(1−2c(i))·z(└i/N_{SF}^{PHICH}┘) (3)

where m=0, 1, 2, . . . , M−1, and M is the size of the PHICH resource set;

i=0, . . . , M_{symb}−1;

M_{symb}=N_{SF}^{PHICH}·Mₛ;

$${N}_{SF}^{PHICH} = \{ \begin{matrix}4 & normal cyclic prefix \\ 2 & extended cyclic prefix\end{matrix} ;$$

wₘ indicates the m^{th} PHICH sequence and is selected from (n_{PHICH,m}^{group},n_{PHICH,m}^{seq}); and

c(i) is a cell-specific scrambling sequence, which may be generated according to Section 7.2 of TS 36.211. The scrambling sequence generator may be initialized with cᵢₙᵢₜ=(└nₛ/2┘+1)·(2N_{ID}^{cell}+1)·2⁹+N_{ID}^{cell} at the start of each subframe.

The plurality of sequences (denoted as [wₘ(0) . . . wₘ(N_{SF}^{PHICH}−1)] m=0, 1, 2, . . . , M−1) may be given by Table 1 (i.e., Table 6.9.1-2 of TS 36.211) where the sequence index n_{PHICH}^{seq} corresponds to the PHICH number within the PHICH group.

TABLE 1
Orthogonal sequences for PHICH

Orthogonal sequence

| Sequence index | Normal cyclic prefix | Extended cyclic prefix |
|---|---|---|
| n_{PHICH}^{seq} | N_{SF}^{PHICH} = 4 | N_{SF}^{PHICH} = 2 |
| 0 | [+1 +1 +1 +1] | [+1 +1] |
| 1 | [+1 −1 +1 −1] | [+1 −1] |
| 2 | [+1 +1 −1 −1] | [+j +j] |
| 3 | [+1 −1 −1 +1] | [+j −j] |
| 4 | [+j +j +j +j] | — |
| 5 | [+j −j +j −j] | — |
| 6 | [+j +j −j −j] | — |
| 7 | [+j −j −j +j] | — |

At step S305, the plurality of sequences of modulation symbols are layer mapped and precoded.

Each of the plurality of sequences of modulation symbols may be layer mapped and precoded. Different from the legacy operation of layer mapping and precoding, multiple PHICH sequences will be layer mapped and precoded in embodiments of the present invention, instead of only one in the legacy solution.

At step S306, the plurality of sequences of modulation symbols are mapped according to the plurality of PHICH sequences in the PHICH resource set.

The resource mapping step is also similar with the legacy operation, except that multiple PHICH sequences are mapped to resource elements instead of only one PHICH resource in the legacy solution.

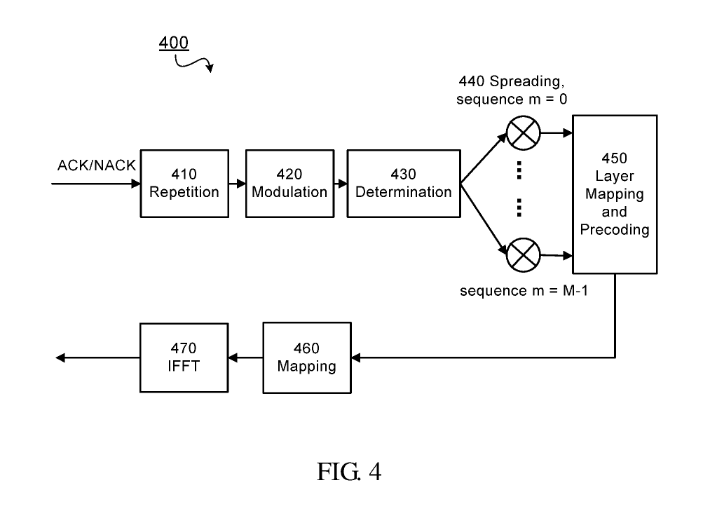

FIG. 4 illustrates a block diagram of modules in a BS according to further embodiments of the invention.

As shown in FIG. 4, an ACK/NACK message is inputted to a repetition module 410. After the ACK/NACK message is repeated predefined times (e.g., 3 times) to increase the transmission robustness. Then the ACK/NACK message is modulated at a modulation module 420, where one or more modulation symbols are generated. A plurality of PHICH sequences are determined at a determination module 730. The modulation symbols are spread at spreading module 440 by using the plurality of PHICH sequences (index m=0, 1, 2, . . . , M−1), resulting in a plurality of sequences of modulation symbols. The plurality of sequences of modulation symbols are outputted to a layer mapping and precoding module 450 and are layer mapped and precoded therein. Then, the plurality of sequences of modulation symbols are mapped at a mapping module 460 according to the plurality of PHICH sequences in the PHICH resource set. Finally, the plurality of sequences of modulation symbols are transformed from the frequency domain to the time domain at an IFFT module 470 and sent to the UE.

As can be appreciated by those skilled in the art, the above arrangement and configuration of the BS is shown for example, rather than limitation. Embodiments of the present disclosure can be applicable to any other suitable arrangement/configuration of BS, but not limited to the specific arrangement/configuration shown in FIG. 4.

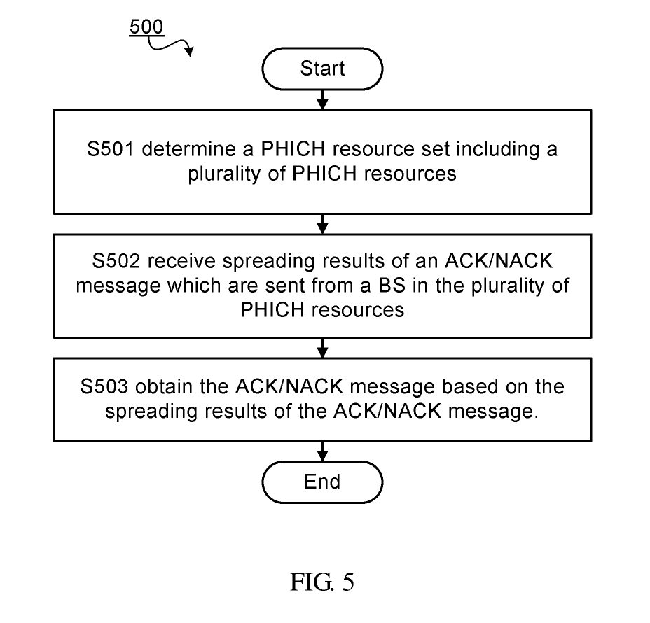

Reference is first made to FIG. 5, which illustrates a flow chart of a method for coverage enhancement in a wireless communication system according to embodiments of the invention. In accordance with embodiments of the present invention, the method 500 may be carried out by a UE or some other suitable device, or may be carried out by an apparatus comprised in the UE.

After the method 500 starts, at step S501, a PHICH resource set including a plurality of PHICH resources is determined.

Step S501 is similar with step S201. Specifically, in accordance with embodiments of the present invention, the PHICH resource set may comprise a plurality of PHICH resources. The PHICH resources may comprise PHICH sequences, powers, and/or other suitable resources.

In accordance with embodiments of the present invention, a PHICH sequence may be identified by an index pair (n_{PHICH,m}^{group},n_{PHICH,m}^{seq}), where n_{PHICH,m}^{group} is the PHICH group number and n_{PHICH,m}^{seq} is the orthogonal sequence index within the group. The PHICH resource set may be determined by determining multiple index pairs indentifying the plurality of PHICH sequences. Specifically, information about the PHICH resource set may be obtained first, and a plurality of index pairs indentifying the plurality of PHICH sequences in the PHICH resource set may be determined based on PHICH parameters and the information about the PHICH resource set. According to embodiments of the present invention, the information about the PHICH resource set may comprise size of the PHICH resource set, which indicates the number of the resources (e.g., sequences) in the PHICH resource set, and/or other suitable information. The PHICH parameters may comprise a spreading factor size used for PHICH modulation, a number of PHICH groups, a factor mapped from the cyclic shift for Demodulation reference signal (DMRS) field, an index for a transport block (TB) of Physical Uplink Shared Channel (PUSCH), an indicator of TDD uplink/downlink configuration, and/or other suitable parameters.

In some embodiments, the information about the PHICH resource set may be initially set as a fixed value at both the UE and the BS. As such, during the HARQ operation, both the UE and the BS will employ the same information about the PHICH resource set, and there is no need to transmit such information in real time. In some other embodiments, if the information about the PHICH resource set is not known to the UE, the BS may inform the UE this information, and the UE may receive the information from the BS, so as to determine the index pairs of the plurality of PHICH sequences.

According to embodiments of the present invention, the plurality of PHICH sequences may belong to one PHICH group. In other words, the plurality PHICH sequences may have the same group index. In this case, the plurality of index pairs indentifying the plurality of PHICH sequences may be determined, e.g., by equation (1).

According to alternative embodiments of the present invention, the plurality of PHICH sequences may belong to multiple PHICH groups. In other words, the plurality PHICH sequences may have different group indices. In this case, the plurality of index pairs indentifying the plurality of PHICH sequences (denoted as (n_{PHICH,m}^{group},n_{PHICH,m}^{seq}), m=0, 1, 2, . . . , M−1) may be determined, e.g., by equation (2).

At step S502, spreading results of an ACK/NACK message which are sent from a BS in the plurality of PHICH resources are received.

As discussed above, the spreading results of an ACK/NACK message may be generated at a BS and sent to the UE in PHICH. The spreading results may be generated according to embodiments of the present invention, such as embodiments described in connection with methods 200-300. As such, the UE may receive the spreading results of the ACK/NACK message in the plurality of PHICH resources from the BS.

At step S503, the ACK/NACK message is obtained based on the spreading results of the ACK/NACK message.

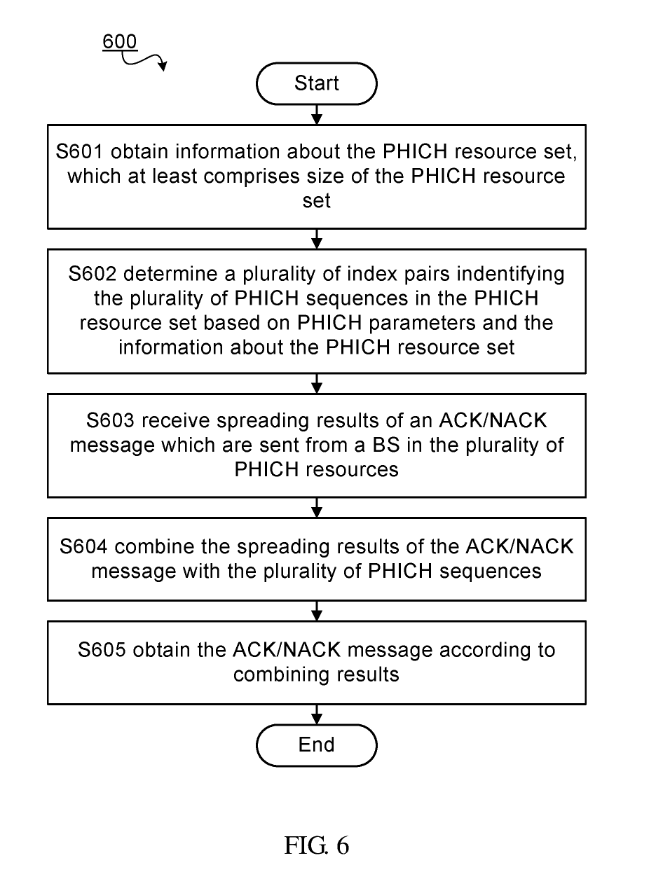

In accordance with embodiments of the present invention, the plurality of PHICH resources may comprise a plurality of PHICH sequences, and the ACK/NACK message may be obtained by combining the spreading results of the ACK/NACK message with the plurality of PHICH sequences; and obtaining the ACK/NACK message according to combining results. The combining operation may be implemented in several ways. For example, the spreading results of the ACK/NACK message may be correlated with the plurality of PHICH sequences, and a sum of correlating results may be calculated as combining results. Details of the combining operation will be described in embodiments in connection with FIG. 6.

In accordance with embodiments of the present invention, method 500 may further comprise a step of judging whether coverage enhancement is needed, wherein the PHICH resource set is determined in response to that the coverage enhancement is needed.

In accordance with embodiments of the present invention, the method 500 may optionally comprise a step of judging whether coverage enhancement is needed. In response to that the coverage enhancement is needed, the PHICH resource set may be determined, as discussed in step S501. According to embodiments of the present invention, whether the coverage enhancement is needed may be determined in several ways. For example, if the SNR is lower than a predefined threshold, it may be determined that the coverage enhancement is needed. As can be appreciated by those skilled in the art, the above example is just for illustration, rather than limitation.

Reference is first made to FIG. 6, which illustrates a flow chart of a method for coverage enhancement in a wireless communication system according to further embodiments of the invention. The method 600 may be considered as an embodiment of the method 500 described above with reference to FIG. 5. In the following description of method 600, the information about the PHICH resource set is first obtained at a UE and then index pairs indentifying the plurality of PHICH sequences is determined based on the information. Then, spreading results of an ACK/NACK message which are received from a BS may be combined with the plurality of PHICH sequences, such that the ACK/NACK message is obtained. However, it is noted that this is only for the purpose of illustrating the principles of the present invention, rather than limiting the scope thereof.

At step S601, information about the PHICH resource set is obtained, which at least comprises size of the PHICH resource set.

In accordance with embodiments of the present invention, the information about the PHICH resource set may be obtained in several ways. For example, the information about the PHICH resource set may be preset at the UE and stored in a memory or a storage, then the UE may retrieve or extract the information at step S601. For another example, the information about the PHICH resource set may be not predefined at the UE. Instead, the UE may receive the information from the BS, e.g., in real time or periodically.

At step S602, a plurality of index pairs indentifying the plurality of PHICH sequences in the PHICH resource set are determined based on PHICH parameters and the information about the PHICH resource set.

According to embodiments of the present invention, the PHICH parameters may comprise a spreading factor size used for PHICH modulation, a number of PHICH groups, a factor mapped from the cyclic shift for DMRS field, an index for a TB of PUSCH, an indicator of TDD uplink/downlink configuration, and/or other suitable parameters. The PHICH parameters may be obtained at both the BS and the UE according to existing ways, which are not detailed here.

Step S602 in method 600 may be considered as an implementation of step S501 in method 500 as described above. The plurality of index pairs indentifying the plurality of PHICH sequences in the PHICH resource set may be determined according to equation (1) if the plurality of PHICH sequences belong to one PHICH group, or may be determined according to equation (2) when the plurality of PHICH sequences belong to multiple PHICH groups.

At step S603, spreading results of an ACK/NACK message which are sent from a BS in the plurality of PHICH resources are received.

In some embodiments, at the UE side, received signals representing spreading results of an ACK/NACK message may be transformed into frequency domain. Then, detection may be carried out based on channel estimation.

At step S604, the spreading results of the ACK/NACK message are combined with the plurality of PHICH sequences.

According to embodiments of the present invention, the UE may use each of the plurality of PHICH sequences, e.g., denoted as (n_{PHICH,m}^{group},n_{PHICH,m}^{seq}) to correlate the receive signals as follows:

$$\overline{d ( m )} = {\sum }_{element \vert in sequence} {w}_{m} ( i mod {N}_{SF}^{PHICH} ) \cdot {w}_{m} ( i mod {N}_{SF}^{PHICH} ) \cdot ( 1 - 2 c ( i ) ) \cdot z ( ⌊ i / {N}_{SF}^{PHICH} ⌋ ) \qquad ( 4 )$$

where

m=0, 1, 2, . . . , M−1, and M is the size of the PHICH resource set;

i=0, . . . , M_{symb}−1;

M_{symb}=N_{SF}^{PHICH}·Mₛ;

$${N}_{SF}^{PHICH} = \{ \begin{matrix}4 & normal cyclic prefix \\ 2 & extended cyclic prefix\end{matrix} ;$$

and

wₘ indicates the m^{th} PHICH sequence and is selected from (n_{PHICH,m}^{group},n_{PHICH,m}^{seq}); and

c(i) is a cell-specific scrambling sequence, which may be generated according to Section 7.2 of TS 36.211.

As all the information transmitted in each resource element carry the same bit, ACK or NACK, a combining operation (also called as “soft combing”) could be carried out as follows, e.g., for better performance in detection.

$$\overline{d ( j )} = {\sum }_{m}^{M - 1} \overline{d ( m )} \qquad ( 5 )$$

It is to be noted that above combining operation is only an example, rather than limitation. As can be appreciated by those skilled in the art, selective combing or other methods could also be used.

At step S605, the ACK/NACK message is obtained according to combining results. By demodulating and decoding the combining results, the ACK/NACK message.

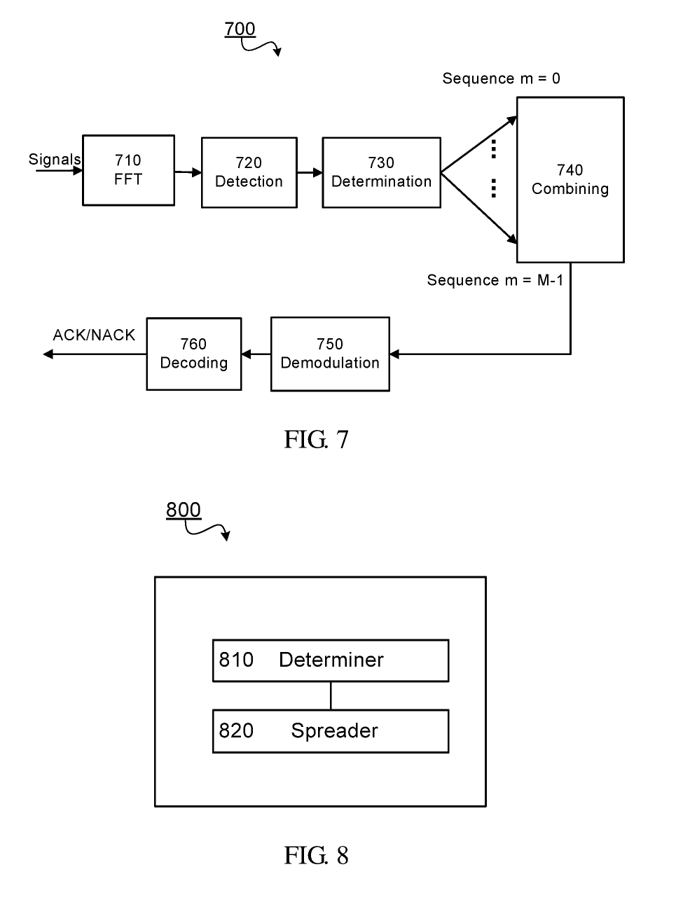

FIG. 7 illustrates a block diagram of modules in a UE according to further embodiments of the invention.

Signals received by the UE are inputted into a FFT module 710 to transform the received signals to the frequency domain, wherein the received signals represent spreading results of the ACK/NACK message. Then, the transformed signals enter a detection module 720, wherein a detection operation may be carried out based on channel estimation. A plurality of PHICH sequences are determined at a determination module 730. The spreading results of the ACK/NACK message are combined with the plurality of PHICH sequences at a combining module 740. The combining results are sent to a demodulation module 750 and then a decoding module 760, such that the ACK/NACK message is obtained at the UE.

As can be appreciated by those skilled in the art, the above arrangement and configuration of the UE is shown for example, rather than limitation. Embodiments of the present disclosure can be applicable to any other suitable arrangement/configuration of UE, but not limited to the specific arrangement/configuration shown in FIG. 7.

Reference is first made to FIG. 8, which illustrates a block diagram of an apparatus for coverage enhancement in a wireless communication system according to embodiments of the invention. The apparatus 800 may be implemented at a BS or some other suitable devices.

According to embodiments of the present invention, the apparatus 800 may comprises: a determiner 810 configured to determine a PHICH resource set including a plurality of PHICH resources; and a spreader 820 configured to spread an ACK/NACK message by using the plurality of PHICH resources, such that spreading results of the ACK/NACK message are sent to a UE in the plurality of PHICH resources.

According to embodiments of the present invention, the plurality of PHICH resources may comprise a plurality of PHICH sequences. The determiner 810 may comprise: an information obtaining unit configured to obtain information about the PHICH resource set, which at least comprises size of the PHICH resource set; an index determining unit configured to determine a plurality of index pairs indentifying the plurality of PHICH sequences in the PHICH resource set based on PHICH parameters and the information about the PHICH resource set, wherein the PHICH parameters comprise: a spreading factor size used for PHICH modulation, a number of PHICH groups, a factor mapped from the cyclic shift for DMRS field, an index for a TB of PUSCH, and an indicator of TDD uplink/downlink configuration.

According to embodiments of the present invention, the plurality of PHICH resources may comprise a plurality of PHICH sequences, and the plurality of PHICH sequences may belong to one PHICH group or belong to multiple PHICH groups.

According to embodiments of the present invention, the spreader may comprise: a modulating unit configured to modulate the ACK/NACK message to obtain modulation symbols; a sequence obtaining unit configured to obtain a plurality of sequences of modulation symbols based on the modulation symbols and the plurality of PHICH sequences; a layer mapping and precoding unit configured to layer map and precode the plurality of sequences of modulation symbols; and a mapping unit configured to map the plurality of sequences of modulation symbols according to the plurality of PHICH sequences in the PHICH resource set.

According to embodiments of the present invention, the apparatus 800 may further comprise: a judger configured to judge whether the UE needs coverage enhancement, wherein the PHICH resource set is determined in response to that the UE needs the coverage enhancement.

According to embodiments of the present invention, the apparatus 800 may further comprise: a sender configured to send information about the PHICH resource set to the UE, wherein the information about the PHICH resource set at least comprises size of the PHICH resource set.

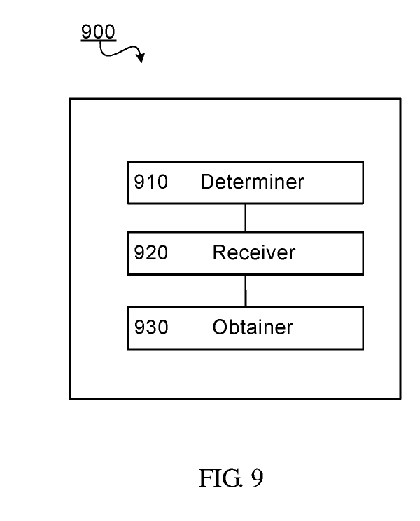

Reference is first made to FIG. 9, which illustrates a block diagram of an apparatus for coverage enhancement in a wireless communication system according to further embodiments of the invention. The apparatus 900 may be implemented at a UE or some other suitable devices.

According to embodiments of the present invention, the apparatus 900 may comprises: a determiner 910 configured to determine a PHICH resource set including a plurality of PHICH resources; a receiver 920 configured to receive spreading results of an ACK/NACK message which are sent from a BS in the plurality of PHICH resources; and an obtainer 930 configured to obtain the ACK/NACK message based on the spreading results of the ACK/NACK message.

According to embodiments of the present invention, the plurality of PHICH resources may comprise a plurality of PHICH sequences. The determiner 910 may comprise: an information obtaining unit configured to obtain information about the PHICH resource set, which at least comprises size of the PHICH resource set; an index determining unit configured to determine a plurality of index pairs indentifying the plurality of PHICH sequences in the PHICH resource set based on PHICH parameters and the information about the PHICH resource set, wherein the PHICH parameters comprise: a spreading factor size used for PHICH modulation, a number of PHICH groups, a factor mapped from the cyclic shift for DMRS field, an index for a TB of PUSCH, and an indicator of TDD uplink/downlink configuration.

According to embodiments of the present invention, the information obtaining unit may comprise a receiving unit configured to receive the information about the PHICH resource set from the BS.

According to embodiments of the present invention, the plurality of PHICH resources may comprise a plurality of PHICH sequences, and the plurality of PHICH sequences may belong to one PHICH group or belong to multiple PHICH groups.

According to embodiments of the present invention, the obtainer 930 may comprise: a combining unit configured to combine the spreading results of the ACK/NACK message with the plurality of PHICH sequences; and a message obtaining unit configured to obtain the ACK/NACK message according to combining results.

According to embodiments of the present invention, the combining unit may comprise: a correlating unit configured to correlate the spreading results of the ACK/NACK message with the plurality of PHICH sequences; and a calculating unit configured to calculate a sum of correlating results as the combining results.

According to embodiments of the present invention, the apparatus 900 may further comprise a judger configured to judge whether coverage enhancement is needed, wherein the PHICH resource set is determined in response to that the coverage enhancement is needed.

It is noted that the apparatus 800 may be configured to implement functionalities as described with reference to FIGS. 2 and 3 and the apparatus 900 may be configured to implement functionalities as described with reference to FIGS. 5 and 6. Therefore, the features discussed with respect to any of methods 200 and 300 may apply to the corresponding components of the apparatus 800. The features discussed with respect to any of methods 500 and 600 may apply to the corresponding components of the apparatus 900. It is further noted that the components of the apparatus 800 or 900 may be embodied in hardware, software, firmware, and/or any combination thereof. For example, the components of the apparatus 800 or 900 may be respectively implemented by a circuit, a processor or any other appropriate selection device. Those skilled in the art will appreciate that the aforesaid examples are only for illustration not limitation.

In some embodiment of the present disclosure, the apparatus 800 or 900 comprises at least one processor. The at least one processor suitable for use with embodiments of the present disclosure may include, by way of example, both general and special purpose processors already known or developed in the future. The apparatus 800 or 900 further comprises at least one memory. The at least one memory may include, for example, semiconductor memory devices, e.g., RAM, ROM, EPROM, EEPROM, and flash memory devices. The at least one memory may be used to store program of computer executable instructions. The program can be written in any high-level and/or low-level compliable or interpretable programming languages. In accordance with embodiments, the computer executable instructions may be configured, with the at least one processor, to cause the apparatus 800 to at least perform according to any of methods 200 and 300 as discussed above, or to cause the apparatus 900 to at least perform according to any of methods 500 and 600 as discussed above.

Based on the above description, the skilled in the art would appreciate that the present disclosure may be embodied in an apparatus, a method, or a computer program product. In general, the various exemplary embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the disclosure is not limited thereto. While various aspects of the exemplary embodiments of this disclosure may be illustrated and described as block diagrams, flowcharts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The various blocks shown in FIGS. 2-3 and 5-6 may be viewed as method steps, and/or as operations that result from operation of computer program code, and/or as a plurality of coupled logic circuit elements constructed to carry out the associated function(s). At least some aspects of the exemplary embodiments of the disclosures may be practiced in various components such as integrated circuit chips and modules, and that the exemplary embodiments of this disclosure may be realized in an apparatus that is embodied as an integrated circuit, FPGA or ASIC that is configurable to operate in accordance with the exemplary embodiments of the present disclosure.

While this specification contains many specific implementation details, these should not be construed as limitations on the scope of any disclosure or of what may be claimed, but rather as descriptions of features that may be specific to particular embodiments of particular disclosures. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Various modifications, adaptations to the foregoing exemplary embodiments of this disclosure may become apparent to those skilled in the relevant arts in view of the foregoing description, when read in conjunction with the accompanying drawings. Any and all modifications will still fall within the scope of the non-limiting and exemplary embodiments of this disclosure. Furthermore, other embodiments of the disclosures set forth herein will come to mind to one skilled in the art to which these embodiments of the disclosure pertain having the benefit of the teachings presented in the foregoing descriptions and the associated drawings.

Therefore, it is to be understood that the embodiments of the disclosure are not to be limited to the specific embodiments disclosed and that modifications and other embodiments are intended to be included within the scope of the appended claims. Although specific terms are used herein, they are used in a generic and descriptive sense only and not for purposes of limitation.

What is claimed is:

1. A method for coverage enhancement in a wireless communication system, comprising:
determining a Physical Hybrid ARQ Indicator Channel (PHICH) resource set including a plurality of PHICH resources; and
spreading an ACK/NACK message by using the plurality of PHICH resources, such that spreading results of the ACK/NACK message are sent to a user equipment (UE) in the plurality of PHICH resources.

2. The method of claim 1, wherein the plurality of PHICH resources comprises a plurality of PHICH sequences, and wherein determining a PHICH resource set including a plurality of PHICH resources comprises:
obtaining information about the PHICH resource set, which at least comprises size of the PHICH resource set;
determining a plurality of index pairs indentifying the plurality of PHICH sequences in the PHICH resource set based on PHICH parameters and the information about the PHICH resource set,
wherein the PHICH parameters comprise: a spreading factor size used for PHICH modulation, a number of PHICH groups, a factor mapped from the cyclic shift for Demodulation reference signal (DMRS) field, an index for a transport block (TB) of Physical Uplink Shared Channel (PUSCH), and an indicator of TDD uplink/downlink configuration.

3. The method of claim 1, wherein the plurality of PHICH resources comprises a plurality of PHICH sequences, and wherein the plurality of PHICH sequences belong to one PHICH group or belong to multiple PHICH groups.

4. The method of claim 1, wherein the plurality of PHICH resources comprises a plurality of PHICH sequences, and wherein spreading an ACK/NACK message by using the plurality of PHICH resources comprises:
modulating the ACK/NACK message to obtain modulation symbols;
obtaining a plurality of sequences of modulation symbols based on the modulation symbols and the plurality of PHICH sequences;
layer mapping and precoding the plurality of sequences of modulation symbols; and
mapping the plurality of sequences of modulation symbols according to the plurality of PHICH sequences in the PHICH resource set.

5. The method of claim 1, further comprising:
judging whether the UE needs coverage enhancement, wherein the PHICH resource set is determined in response to that the UE needs the coverage enhancement.

6. The method of claim 1, further comprising:
sending information about the PHICH resource set to the UE, wherein the information about the PHICH resource set at least comprises size of the PHICH resource set.

7. A method for coverage enhancement in a wireless communication system, comprising:
determining a Physical Hybrid ARQ Indicator Channel (PHICH) resource set including a plurality of PHICH resources;
receiving spreading results of an ACK/NACK message which are sent from a base station (BS) in the plurality of PHICH resources; and
obtaining the ACK/NACK message based on the spreading results of the ACK/NACK message.

8. The method of claim 7, wherein the plurality of PHICH resources comprises a plurality of PHICH sequences, and wherein determining a PHICH resource set including a plurality of PHICH resources comprises:
obtaining information about the PHICH resource set, which at least comprises size of the PHICH resource set;
determining a plurality of index pairs indentifying the plurality of PHICH sequences in the PHICH resource set based on PHICH parameters and the information about the PHICH resource set,
wherein the PHICH parameters comprise: a spreading factor size used for PHICH modulation, a number of PHICH groups, a factor mapped from the cyclic shift for Demodulation reference signal (DMRS) field, an index for a transport block (TB) of Physical Uplink Shared Channel (PUSCH), and an indicator of TDD uplink/downlink configuration.

9. The method of claim 8, wherein obtaining information about the PHICH resource set comprises:
receiving the information about the PHICH resource set from the BS.

10. The method of claim 7, wherein the plurality of PHICH resources comprises a plurality of PHICH sequences, and wherein the plurality of PHICH sequences belong to one PHICH group or belong to multiple PHICH groups.

11. The method of claim 7, wherein the plurality of PHICH resources comprises a plurality of PHICH sequences, and wherein obtaining the ACK/NACK message based on the spreading results of the ACK/NACK message comprises:
combining the spreading results of the ACK/NACK message with the plurality of PHICH sequences; and
obtaining the ACK/NACK message according to combining results.

12. The method of claim 11, wherein combining the spreading results of the ACK/NACK message with the plurality of PHICH sequences comprises:
correlating the spreading results of the ACK/NACK message with the plurality of PHICH sequences; and
calculating a sum of correlating results as the combining results.

13. The method of claim 7, further comprising:
judging whether coverage enhancement is needed, wherein the PHICH resource set is determined in response to that the coverage enhancement is needed.

14. An apparatus for coverage enhancement in a wireless communication system, comprising:
a determiner configured to determine a Physical Hybrid ARQ Indicator Channel (PHICH) resource set including a plurality of PHICH resources; and
a spreader configured to spread an ACK/NACK message by using the plurality of PHICH resources, such that spreading results of the ACK/NACK message are sent to a user equipment (UE) in the plurality of PHICH resources.

15. The apparatus of claim 14, wherein the plurality of PHICH resources comprises a plurality of PHICH sequences, and wherein the determiner comprises:
an information obtaining unit configured to obtain information about the PHICH resource set, which at least comprises size of the PHICH resource set;
an index determining unit configured to determine a plurality of index pairs indentifying the plurality of PHICH sequences in the PHICH resource set based on PHICH parameters and the information about the PHICH resource set,
wherein the PHICH parameters comprise: a spreading factor size used for PHICH modulation, a number of PHICH groups, a factor mapped from the cyclic shift for Demodulation reference signal (DMRS) field, an index for a transport block (TB) of Physical Uplink Shared Channel (PUSCH), and an indicator of TDD uplink/downlink configuration.

16. The apparatus of claim 14, wherein the plurality of PHICH resources comprises a plurality of PHICH sequences, and wherein the plurality of PHICH sequences belong to one PHICH group or belong to multiple PHICH groups.

17. The apparatus of claim 14, wherein the plurality of PHICH resources comprises a plurality of PHICH sequences, and wherein the spreader comprises:
a modulating unit configured to modulate the ACK/NACK message to obtain modulation symbols;
a sequence obtaining unit configured to obtain a plurality of sequences of modulation symbols based on the modulation symbols and the plurality of PHICH sequences;
a layer mapping and precoding unit configured to layer map and precode the plurality of sequences of modulation symbols; and
a mapping unit configured to map the plurality of sequences of modulation symbols according to the plurality of PHICH sequences in the PHICH resource set.

18. The apparatus of claim 14, further comprising:
a judger configured to judge whether the UE needs coverage enhancement, wherein the PHICH resource set is determined in response to that the UE needs the coverage enhancement.

19. The apparatus of claim 14, further comprising:
a sender configured to send information about the PHICH resource set to the UE, wherein the information about the PHICH resource set at least comprises size of the PHICH resource set.

20. An apparatus for coverage enhancement in a wireless communication system, comprising:
a determiner configured to determine a Physical Hybrid ARQ Indicator Channel (PHICH) resource set including a plurality of PHICH resources;
a receiver configured to receive spreading results of an ACK/NACK message which are sent from a base station (BS) in the plurality of PHICH resources; and
an obtainer configured to obtain the ACK/NACK message based on the spreading results of the ACK/NACK message.

21. The apparatus of claim 20, wherein the plurality of PHICH resources comprises a plurality of PHICH sequences, and wherein the determiner comprises:
an information obtaining unit configured to obtain information about the PHICH resource set, which at least comprises size of the PHICH resource set;
an index determining unit configured to determine a plurality of index pairs indentifying the plurality of PHICH sequences in the PHICH resource set based on PHICH parameters and the information about the PHICH resource set,
wherein the PHICH parameters comprise: a spreading factor size used for PHICH modulation, a number of PHICH groups, a factor mapped from the cyclic shift for Demodulation reference signal (DMRS) field, an index for a transport block (TB) of Physical Uplink Shared Channel (PUSCH), and an indicator of TDD uplink/downlink configuration.

22. The apparatus of claim 20, wherein the information obtaining unit comprises:
a receiving unit configured to receive the information about the PHICH resource set from the BS.

23. The apparatus of claim 20, wherein the plurality of PHICH resources comprises a plurality of PHICH sequences, and wherein the plurality of PHICH sequences belong to one PHICH group or belong to multiple PHICH groups.

24. The apparatus of claim 20, wherein the plurality of PHICH resources comprises a plurality of PHICH sequences, and wherein the obtainer comprises:
a combining unit configured to combine the spreading results of the ACK/NACK message with the plurality of PHICH sequences; and
a message obtaining unit configured to obtain the ACK/NACK message according to combining results.

25. The apparatus of claim 24, wherein the combining unit comprises:
a correlating unit configured to correlate the spreading results of the ACK/NACK message with the plurality of PHICH sequences; and
a calculating unit configured to calculate a sum of correlating results as the combining results.

26. The apparatus of claim 20, further comprising:
a judger configured to judge whether coverage enhancement is needed, wherein the PHICH resource set is determined in response to that the coverage enhancement is needed.
